(19) United States
(12) Patent Application Publication
(10) Pub. No.: US 2013/0326063 A1
(43) Pub. Date: Dec. 5, 2013

(54) TECHNIQUES FOR WORKLOAD DISCOVERY AND ORGANIZATION

(71) Applicants: Lloyd Leon Burch, Payson, UT (US); Jeremy Ray Brown, Orem, UT (US); Jason Allen Sabin, Lehi, UT (US)

(72) Inventors: Lloyd Leon Burch, Payson, UT (US); Jeremy Ray Brown, Orem, UT (US); Jason Allen Sabin, Lehi, UT (US)

(21) Appl. No.: 13/485,287

(22) Filed: May 31, 2012

(51) Int. Cl. G06F 15/173

(52) U.S. Cl. 709/226

(57) ABSTRACT

Techniques for workload discovery and organization are presented. A workload when initiated on a network self-inspects the network for other workloads processing as a collection over the network. Shared communication information is used by the workload to dynamically join the collection. A network address for the initiated workload is then added to a shared Domain Name System (DNS) database being maintained for the network and the collection.

### BACKGROUND

Cloud computing is rapidly changing the Internet into a collection of clouds, which provide a variety of computing resources, storage resources, and, in the future, a variety of resources that are currently unimagined.

Yet, frequently it is difficult to effectively provide a given service from a single environment. This is so because a product or service often requires the cooperation of multiple services in providing functionality sufficient to be considered holistic.

Moreover, because services are being deployed to more and more diverse processing environments, some processing environments which were never anticipated, any service that relies on other services to be present requires substantial configuration to ensure that the deployed services are properly communicating with one another within new processing environments. Services may also communicate with one another using shared information (e.g., encryption, keys, etc.).

As a result, services that are dependent on other services and/or use shared information to communicate with one another are either not deployed to new cloud environments or are substantially configured and manually initiated in the new cloud environments to ensure proper communication occurs with the services in the new cloud environments. Heavy manual configuration and initiation defeat many of the very benefits associated with automatic and remote processing in cloud environments.

### SUMMARY

Various embodiments of the invention provide techniques for workload discovery and organization. Specifically, and in one embodiment a method for workload discovery and organization is presented.

Specifically and in an embodiment, a network address is received for network communications within a network. Next, a network protocol is used for identifying resources available on the network. Finally, a collection of workloads is dynamically joined, using the network communications for one or more of the resources.

### BRIEF DESCRIPTION OF THE DRAWINGS

FIG. 1 is a diagram depicting a technique for a self-organizing workload, according to the techniques presented herein.

FIG. 2 is a diagram of a method for workload discovering and organizing, according to embodiments presented herein.

FIG. 3 is a diagram of another method for workload discovering and organizing, according to embodiments presented herein.

FIG. 4 is a diagram of a workload discovery and organizing system, according to embodiments presented herein.

### DETAILED DESCRIPTION

A “resource” includes a user, service, system, device, directory, data store, groups of users, combinations and/or collections of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc.

A “workload” as used herein refers to a special type of resource, such as a Virtual Machine (VM), an Operating System (OS), a cloud, a portion of a cloud, a set of coordinating services, a hardware device, an agent, an application, or various combinations of these things. The “workload” can also include a variety of other resources. For example, a workload for identity management may include a variety of secure database, a variety of authentication services, and a variety of network machines.

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X and be logically combined with another computing resource at network site Y to form a logical processing environment.

The phrases “processing environment,” “cloud processing environment,” and the term “cloud” may be used interchangeably and synonymously herein.

Moreover, it is noted that a “cloud” refers to a logical and/or physical processing environment as discussed above.

Various embodiments of this invention can be implemented in existing network architectures. For example, in some embodiments, the techniques presented herein are implemented in whole or in part in the Novell® operating system products, directory-based products, cloud-computing-based products, and other products distributed by Novell®, Inc., of Waltham, Mass.

Also, the techniques presented herein are implemented in machines, such as processor or processor-enabled devices (hardware processors). These machines are configured and programmed to specifically perform the processing of the methods and systems presented herein. Moreover, the methods and systems are implemented and reside within a non-transitory computer-readable storage media or machine-readable storage medium and are processed on the machines configured to perform the methods.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

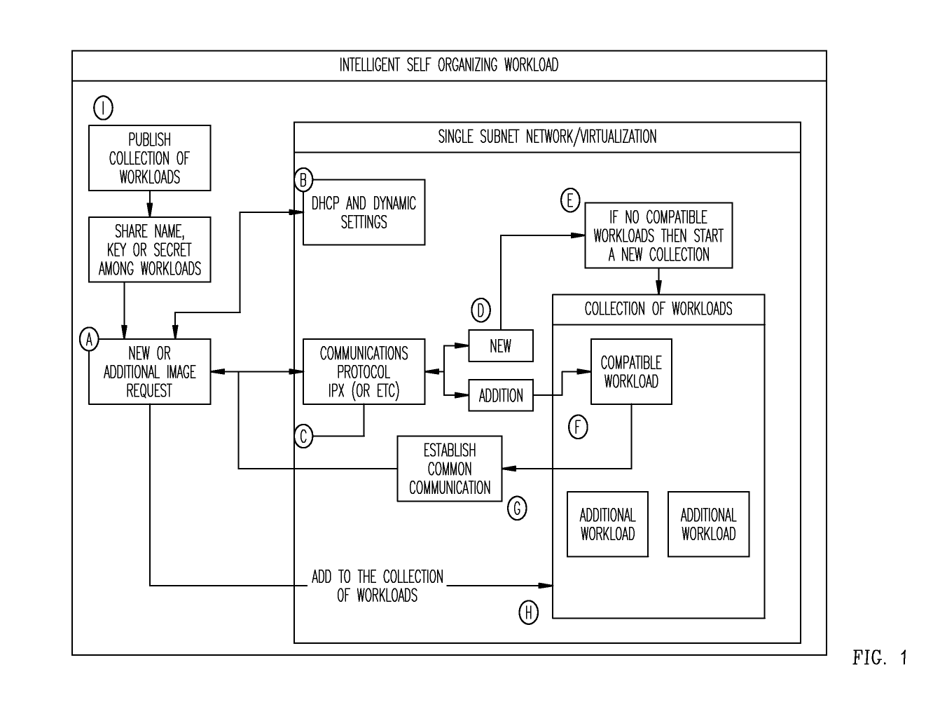

It is within this context that embodiments of the invention are now discussed within the context of the FIGS. 1-4.

FIG. 1 is a diagram depicting a technique for a self-organizing workload, according to the techniques presented herein. It is noted that the FIG. 1 is presented for purposes of illustration and comprehension. It is to be understood that other arrangements and/or components can be used to achieve the teachings presented herein and below.

The components of the FIG. 1 are implemented in non-transitory and processor-readable storage medium and are executed on physical processors on one or more networks. Each processor specifically configured to execute the components.

The embodiments herein proceed as follows:

The first step A is where a workload is taken and introduced to a network/virtualization of a customer. As the workload comes up in the environment, it initializes and starts talking/communicating to/with the network.

In step B, the first thing is a Dynamic Host Configuration Protocol (DHCP) address is received from a network card for the workload as it comes up on a device. It is noted that static addresses can be handled as well. The DHCP address is returned to the workload, such that that workload is now able to see other machines around it on the network.

In step C, network communication is established with the workload in its new environment and linkages to other resources occur. In an embodiment, Inter Packet Exchange (IPX) protocol is used by the workload in its new processing environment. Share information can also be used to establish a new random group (looking for a type of service) or agreed upon information when the group is initially published. The shared information can be multiple types to ensure that users do not step on each other.

In step D, a shared communication is sent out over the network. Here, the workload sees a resource that the workload recognizes as a collection to join. Or, the workload wants to start a new collection because there is nothing that is recognizable in the network to the workload.

In step E, if no one is on the network and no existing collection of workloads are organized on the network, a new collection is established by the workload, such that the workload now responds to new requests and establishes a unique collection that can respond to new requests that join the network.

Step F indicates a resource was located in an existing collection of the network that is capable of communicating with the workload. Communication with the resource is made and the workload attempts to see if there are other collections that the workload can join within the network. That is, the workload can dynamically join multiple different collections within the network.

In step G, a common communication is established with the collection and information is sent back that validates and setup the collection for talking to the new workload. This is multiple exchanges but will end up as validated with a shared Domain Name System (DNS) to see the other members of the collection. This is an improvement over convention approaches where the DNS was constantly changing, which caused issues with preconfigured products.

Step H is a final step where final information is sent back for purposes of sharing a DNS where a collection of workloads is organized within the network. In an embodiment, there is no reason the collection couldn't be an entire private subnet that is routed internally and independent of a network provider.

In step I, share information is built after the workloads are configured or before some workloads are actually configured. To avoid conflicts some unique information is established, such as a unique name, company name, timestamp for publishing, password, key, secret that collections share, etc. Again, this is just to ensure that a collection can be initiated and loaded regardless of what is in the environment where the collection is being loaded. It is noted that there is also an ability to add additional workloads to a collection at any time if a workload has the correct shared information. There is also an ability to have a system configured so all products of a predefined type can talk to each other on a secure communication channel independent of the current environment.

One variation on techniques presented herein is to let machines handle multiple collections and talk to each other with the DNS being inclusive of all the machines on the network.

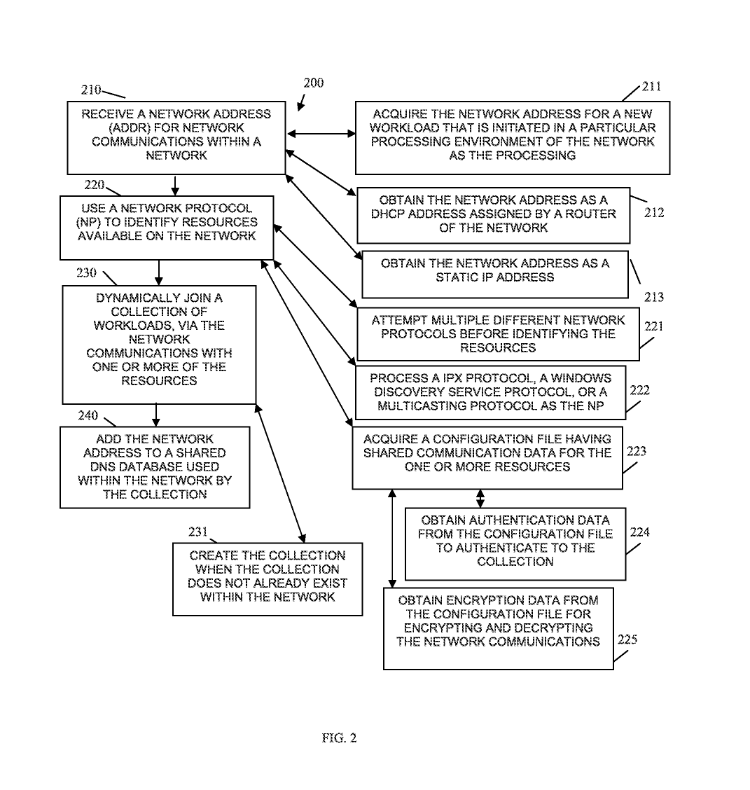

FIG. 2 is a diagram of a method 200 for workload discovering and organizing, according to embodiments presented herein. The method 200 (herein referred to as “workload organizer”) is implemented, programmed, and resides within a non-transitory machine-readable storage medium that executes on one or more processors of a network. The network may be wired, wireless, or a combination of wired and wireless.

In an embodiment, the workload organizer processes within a customized workload as part of initial startup logic. In this manner, the workload organizer processes when a workload having the workload organizer is initiated within a processing environment of a network.

At 210, the workload organizer receives a network address for network communications within a network. That is, the workload organizer uses an assigned network Internet Protocol (IP) address provided by a router, proxy, and/or gateway of the network for initial network communications.

According to an embodiment, at 211, the workload organizer acquires the network address for a new workload that is initiated in a particular processing environment of the network. That is, the workload organizer is part of a new workload being initiated in a particular processing environment of the network. It is noted that multiple processing environments can exists within the network and in some cases the network can be a subnet, Intranet, and the like as discussed above with reference to the FIG. 1.

In one scenario, at 212, the workload organizer obtains the network address as a DHCP address that is dynamically assigned by a router, proxy, and/or gateway of the network.

In an alternative situation, at 213, the workload organizer obtains the network address as a static IP address. This can be preconfigured with the workload organizer or part of a configuration file associated with the workload organizer.

At 220, the workload organizer uses a network protocol to identify resources available on the network. So, once the workload organizer has a network address and is capable of trying to communicate over the network, the workload organizer uses a network protocol to attempt communications and dynamically discover resources processing on the network. Specifically, the workload organizer is looking for other workloads that are processing as a collection within the network for which the workload organizer can join.

In an embodiment, at 221, the workload organizer attempts multiple different network protocols before identifying the resources. In other words, a variety of configured network protocols can be preconfigured in the workload organizer and each of the protocols are used or attempted trying to identifying network resources (workloads) organized as a collection on the network.

For example, at 222, the workload organizer processes an IPX protocol, a WINDOWS® Discovery Service protocol, or any multicasting protocol as the network protocol.

According to an embodiment, at 223, the workload organizer acquires a configuration file having shared communication data for the one or more resources. This file includes unique information that can be used by the workload organizer to join a collection of resources (workloads) on the network. Some of the information included in the shared configuration file was discussed above with reference to the FIG. 1.

Continuing with the embodiment of 223 and at 224, the workload organizer obtains authentication date from the configuration file to authenticate to the collection. A specific authentication mechanism and credentials required can be identified or referenced in the shared communication data.

Still continuing with the embodiment of 223 and at 225, the workload organizer obtains encrypted data from the configuration file for encrypting and decrypting the network communications. These can be keys or details about how to obtain keys for purposes of utilizing encrypted communications.

At 230, the workload organizer dynamically joins a collection of workloads, via the network communications using the one or more resources. That is, one of the resources responds and permits the workload organizer to join the collection as a new or added workload. In this manner, the workload organizer (packaged as part of startup logic for a workload) dynamically discovers a collection in a network and self-organizes itself by joining the discovered collection.

According to an embodiment, at 231, the workload organizer creates the collection when the collection does not already exist within the network. So, when no existing collection is present, the workload organizer can start a new collection for which other workloads can dynamically join.

In an embodiment, at 240, the workload organizer adds the network address to a shared DNS database used within the network by the collection. So, namespace management occurs for the collection within the network, even when workloads span multiple disparate processing environments because management of the DNS database occurs based on a collection within a network.

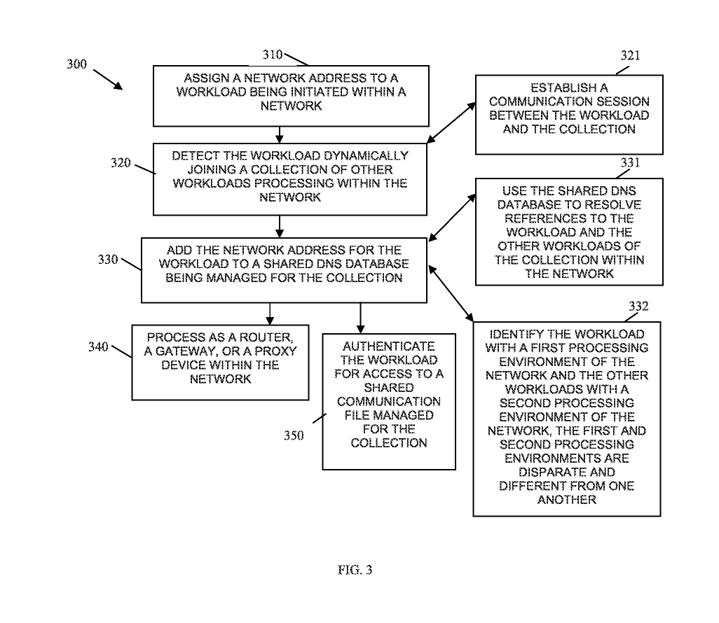

FIG. 3 is a diagram of another method 300 for workload discovering and organizing, according to embodiments presented herein. The method 300 (herein after referred to as “workload initiator”) is implemented, programmed, and resides within a non-transitory machine-readable storage medium that executes on one or more processors of a network. The network may be wired, wireless, or a combination of wired and wireless.

The workload initiator presents another and in some instances an enhanced perspective of the workload organizer represented by the method 200 of the FIG. 2 (discussed above).

At 310, the workload initiator assigns a network address to a workload being initiated within a network. The processing discussed above with reference to the FIG. 2 was described from the perspective of the workload being initiated within a network. The processing of the workload initiator is described from the perspective of a network device or service where the workload is being initiated.

At 320, the workload initiator detects the workload dynamically joining a collection of other workloads processing within the network.

For example, at 321, the workload initiator establishes a communication session between the workload and the collection. Routing tables or session tables can be used along with session keys and the like to facilitate the establishment of the communication session.

At 330, the workload initiator adds the network address for the workload to a shared DNS database being managed for the collection. The shared DNS permits rapid address resolution and name space resolution for workloads within the collection.

According to an embodiment, at 331, the workload initiator uses the shared DNS database to resolve references to the workload and the other workloads of the collection within the network.

In another situation, at 332, the workload initiator identifies the workload with a first processing environment of the network and the other workloads with a second processing environment of the network. Here, the first and second processing environments are disparate and different from one another. Thus, the workloads of the collection can span different processing environments over the same network and be managed and communicate via the shared DNS and other shared communication information.

According to an embodiment, at 340, the workload initiator processes as a router, a gateway, and/or a proxy device within the network.

In another situation, at 350, the workload initiator authenticates the workload for access to a shared communication file managed for the collection. Aspects of the shared communication file were discussed above with reference to the FIGS. 1 and 2.

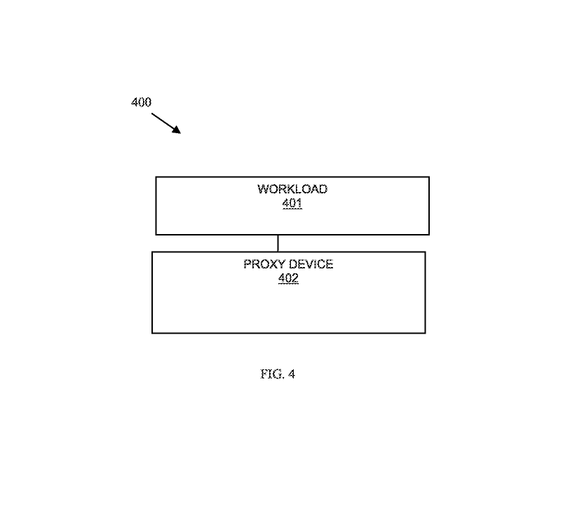

FIG. 4 is a diagram of a workload discovery and organizing system 400, according to embodiments presented herein. The components of the workload discovery and organizing system 400 are implemented, programmed, and reside within a non-transitory machine-readable storage medium that executes on one or more processors of a network. The network may be wired, wireless, or a combination of wired and wireless.

In an embodiment, the workload discovery and organizing system 400 implements, inter alia, the processing associated with the methods 200 and 300 of the FIGS. 2 and 3, respectively.

The workload discovery and organizing system 400 includes a workload 401 and a proxy device 402. Each of these and their interactions with one another will now be discussed in turn.

The workload discovery and organizing system 400 includes at least one first processing device having the workload 401. The workload 401 is implemented as executable instructions that reside in a non-transitory computer-readable storage medium and that execute on the processing device of the network. Example aspects of the workload 401 were discussed above with reference to the FIGS. 1 and 2.

The workload 401 is configured to be initiated on the first processing device and configured to identify a collection of other workloads that is processing and communicating over the network.

The workload discovery and organizing system 400 also includes a proxy device 402. Example aspects of the proxy device 402 were discussed above with reference to the FIGS. 1 and 3.

The proxy device 402 is configured to dynamically add the workload 401 to the collection and to also facilitate the workload 401 in dynamically joining the collection for communications over the network.

According to an embodiment, the proxy device 402 is also configured to assign a network address to the workload 401 on the processing device. For example, the proxy device 402 is configured to add the network address to a DNS database being maintained on the network for the collection.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors configured to perform the method, comprising:
receiving a network address for network communications within a network;
using a network protocol to identify resources available on the network; and
dynamically joining a collection of workloads, via the network communications with one or more of the resources.

2. The method of claim 1, wherein receiving further includes acquiring the network address for a new workload that is initiated in a particular processing environment of the network as the method.

3. The method of claim 1, wherein receiving further includes obtaining the network address as a Dynamic Host Configuration Protocol (DHCP) address assigned by a router of the network.

4. The method of claim 1, wherein receiving further includes obtaining the network address as a static Internet Protocol (IP) address.

5. The method of claim 1, wherein using further includes attempting multiple different network protocols before identifying the resources.

6. The method of claim 1, wherein using further includes processing an Internetwork Packet Exchange (IPX) protocol, a Windows Discovery Service protocol, or a multicasting protocol as the network protocol.

7. The method of claim 1, wherein using further includes acquiring a configuration file having shared communication data for the one or more resources.

8. The method of claim 7, wherein acquiring further includes obtaining authentication data from the configuration file to authenticate to the collection.

9. The method of claim 7, wherein acquiring further includes obtaining encryption data from the configuration file for encrypting and decrypting the network communications.

10. The method of claim 1, wherein dynamically joining further includes creating the collection when the collection does not exists within the network.

11. The method of claim 1 further comprising, adding the network address to a shared Domain Name System (DNS) database used within the network by the collection.

12. A method implemented in a non-transitory machine-readable storage medium and processed by one or more processors configured to perform the method, comprising:
assigning a network address to a workload being initiated within a network;
detecting the workload dynamically joining a collection of other workloads processing within the network; and
adding the network address for the workload to a shared Domain Name System (DNS) database being managed for the collection.

13. The method of claim 12 further comprising, processing the method as a router, a gateway, or a proxy device within the network.

14. The method of claim 12 further comprising, authenticating the workload for access to a shared communication file managed for the collection.

15. The method of claim 12, wherein detecting further includes establishing a communication session between the workload and the collection.

16. The method of claim 12, wherein adding further includes using the shared DNS database to resolve references to the workload and the other workloads of the collection within the network.

17. The method of claim 12, wherein adding further includes identifying the workload with a first processing environment of the network and the other workloads with a second processing environment of the network, the first and second processing environments disparate and different from one another.

18. A system, comprising:
a first processing device having a workload implemented and residing as instructions within a non-transitory computer-readable storage medium that processes on the first processing device; and
a proxy device;
wherein the workload is initiated on the first processing device and is configured to identify a collection of other workloads that is processing and communicating over a network, the proxy device configured to add the workload to the collection and to facilitate the workload in dynamically joining the collection for communications.

19. The system of claim 18, wherein the proxy device is configured to assign a network address to the workload when initiated on the processing device.

20. The system of claim 19, wherein the proxy device is configured to add the network address to a Domain Name System (DNS) database being maintained on the network for the collection.
